(19) United States
(12) Patent Application Publication
(10) Pub. No.: US 2005/0021805 A1
(43) Pub. Date: Jan. 27, 2005

(54) System and method for transmitting multimedia information streams, for instance for remote teaching

(76) Inventors: Gianluca De Petris, Torino (IT); Alessandro Costa Laia, Torino (IT); Giovanni Cordara, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/491,398

(22) PCT Filed: Sep. 27, 2002
(86) PCT No.: PCT/IT02/00617

(30) Foreign Application Priority Data
Oct. 1, 2001 (IT) TOO1A000930

(51) Int. Cl. G06F 15/16

(52) U.S. Cl. 709/231; 709/200

(57) ABSTRACT

A system for accomplishing the transmission of a multimedia stream between at least a transmitter (3) and at least a receiver (5). The multimedia stream comprises an audio/video stream with at least an information stream associated thereto. To at least some of the objects included in the multimedia stream is associated a respective description and space-type characterisation, so that each receiver (5) is able to interact with the aforesaid objects changing their space-time position relative to the other stream independently from the transmitter (3) and from the other receivers. Preferential application to remote teaching techniques.

### TECHNICAL FIELD

The present invention relates to the transmission of multimedia information streams, in particular in regard to the creation and fruition thereof.

Naturally, the term “transmission” is used herein in its broadest sense to indicate the transfer of information accomplished according to any form and manner and thus includes, for instance, the recording of the aforesaid information streams on recording supports such as Hard-Disk, DVD-ROM or CD-ROM.

The present invention was developed with particular attention to its possible application to remote teaching techniques.

### BACKGROUND ART

In this application field, the state of the art reveals the existence of different systems depending on whether the lesson is to be viewed in real time or after a delay.

For instance, for real-time viewing it is usual to resort to videoconferencing systems, or to so-called “group TV” techniques, or else to proprietary technologies of varying nature.

Also known are remote teaching systems usable on CD or via Internet, also based on the employment of proprietary technologies or to HTML formats.

In addition, the document WO-A-00/77678 discloses a method and a system that allow a user of an advanced multimedia platform of the television/interactive (IMP) type to identify and select a plurality of objects contained in an encoded video session (EVS). By means of the known system it is possible to access the objects selected by the user through a graphic user interface with an additional processing capability at the hyperlink level of the Internet Access Information (IAI) type.

The document WO-A-98/47084 discloses a method for describing and linking an object-based video signal. The method is based on the construction of a stream associated to a video sequence in any common format. Said associated stream contains text descriptions, voice annotations, image characteristics, URL links and so-called Java applets able to be recorded for some objects within each frame of the video signal.

Lastly, U.S. Pat. No. 5,774,666 (and, with some differences, EP-A-0 840 241) disclose solutions providing for the use of a hypertext navigation function, of the browser type, within a video signal, which must therefore be prepared for this purpose with a pre-processing or pre-directing function.

Essentially, to date there are no systems based on standard technologies, such as to allow an instructor/speaker to perform the following activities at the same time:
recording a normal classroom lesson/lecture in the presence of students/audience members,
holding a remote lesson in a classroom connected with different transmission means (Ethernet, satellite, etc.) to the classroom of the “real” lesson,
recording in multimedia form the lesson (audio and video) plus the support material (transparencies or slides, television camera shots from a projector, any external contributions composed by a video recorder or Personal Computer, etc.),
implicitly indexing the lesson during the recording session, with no need for post-editing the lesson, and
perform the above functions without requiring the aid of a director, an engineer or an external entity so tasked.

Equally, at present there are no systems based on standard technologies such as to allow students simultaneously to perform the following functions:
viewing the lesson in real time (streaming) or after a delay (downloading),
viewing the lesson with control over the graphic interface and the supporting material (for instance current transparency or slide, video in the foreground, etc.) also during a lesson in real time, and
viewing the same lesson through any type of network (modem, Ethernet, ISDN, satellite, etc.) with selectable quality depending on network type, but with the same contents.

### DISCLOSURE OF THE INVENTION

The aim of the present invention therefore is to allow the simultaneous performance of the described functions through the use of standard (thus not proprietary) technologies, in order to enable the creation of a service open for everyone (i.e., of the “open” type), though with the capability of managing such access limitations as to safeguard intellectual property rights.

According to the present invention, this aim is achieved thanks to a system and method having the characteristics specifically described in the claims that follow.

Moreover, the aim is achieved by data processing products loadable into memory of digital processors for implementing the method according to the invention.

In the embodiment currently preferred, the solution according to the invention provides for the use of a complete platform comprising the following subsystems:
management of the multimedia contents and of the users (integrated data base),
management of access rights (content creation/update side and fruition side),
content production (if required, in protected form),
network broadcasting and recording, and
fruition.

Use of the MPEG-4 standard (preferred, but not imperative, choice for purposes of implementing the invention) has numerous advantages.

In the first place, the compression ratio allowed by the MPEG-4 standard makes both the video signal and the audio signal of high quality for narrow band channels such as a modem channel. The recording occupies little space, reducing storage costs.

The subdivision of the audiovisuals into synchronised elementary objects, offered by the MPEG-4 standard, allows for a high degree of interaction on the student's part, even in purely broadcasting scenarios.

The high level of security is assured by the secrecy of the key, not of the algorithms and of the protocols.

### BRIEF DESCRIPTION OF DRAWINGS

The invention will now be described, purely by way of non limiting example, with reference to the accompanying drawings, in which:

FIG. 1 schematically shows the possible organisation of a system according to the invention as a whole,

FIG. 2 is a functional block diagram representing the organisation of the system according to the invention viewed from the transmitter or “instructor” side (content creation), and

FIG. 3 is an additional functional block diagram showing the possible organisation of a system according to the invention viewed from the receiver or “student” side (content fruition).

### BEST MODE FOR CARRYING OUT THE INVENTION

By way of foreword, it should be noted that, although the system according to the invention was developed in view of its possible preferential application to remote teaching techniques, its field of possible application is quite general, and hence not limited to the specific application whereto reference is made hereinafter.

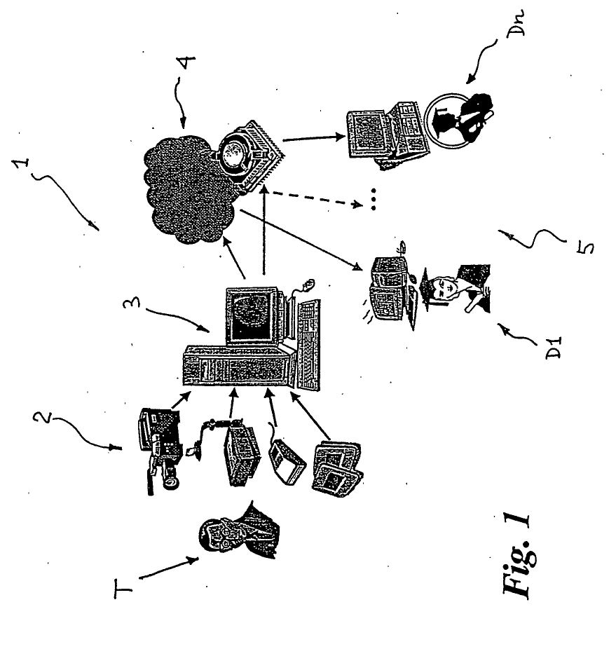

The system according to the invention, globally indicated as 1 in FIG. 1, comprises a set of sources of didactic material, globally indicated as 2, made available to the teacher T. The aforesaid sources of didactic material comprise, for instance, a microphone for capturing the voice of the teacher T, a television camera to obtain his/her image, videocassettes, slides or transparencies recorded in such a way as to be legible by a computer system, for instance on a diskette (typically as JPEG slides). Said sources also comprise at least a device (such as a mouse, a keyboard, etc.) that allows the teacher to generate system commands corresponding, for instance, to a slide or transparency change, to the presentation of a signal from a projector, etc.

The sources are thus able to generate as their output both analogue signals (for instance the audio signal), destined to be converted into digital form, and signals already available in digital form at the source (for instance, this is the case of JPEG slides).

The reference 3 indicates one or more digital processors or computers serving as control stations and tasked with conversing into digital format, if necessary, with coding, compressing and possibly protecting the didactic material, with the consequent generation of a multimedia digital stream destined to be transmitted over various types of networks (IP multicast, satellite, etc.) or to be stored.

The reference number 4 indicates in general the transmission support, embodied according to any known technology for this purpose (one or more networks, for instance Ethernet 10/100 Mbit/s, satellite, modem, CD-ROM, Hard Disk, etc.) and such as to be transparent to the system.

Also provided are one or more computers serving as receiving computers 5, one for each student D1, . . . , Dn, tasked with receiving the multimedia lesson from a network or physical support (Hard-Disk, CD-ROM, etc.), possibly decrypting said lesson, decoding it, decompressing it and presenting it to the final user, with the possibility for the latter to interact locally with the received multimedia stream.

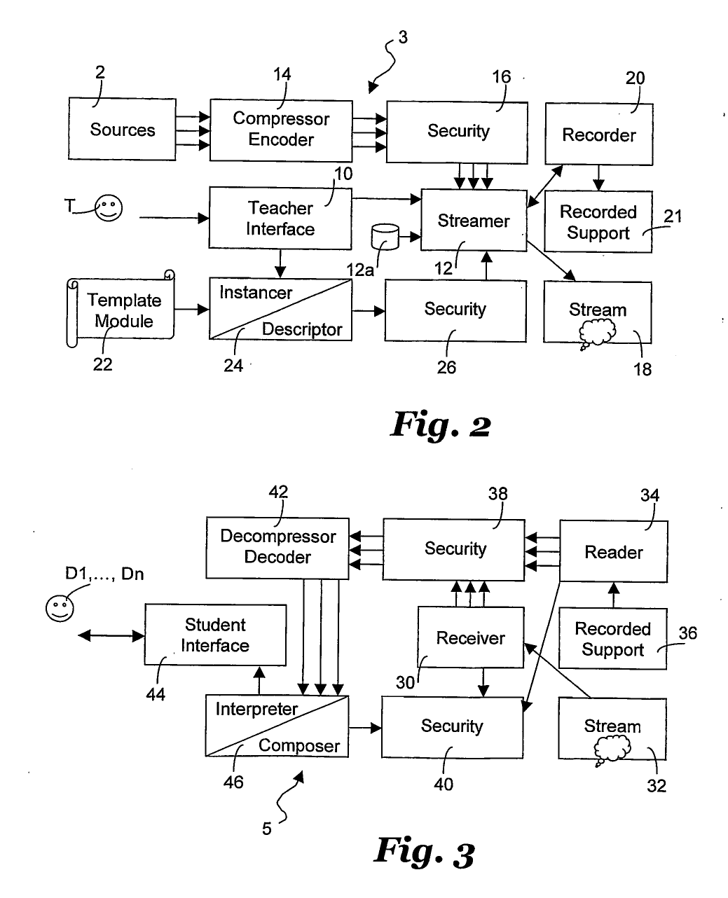

The block diagram of FIG. 2 schematically shows the flow of the data produced from the teacher side.

The characteristics of each module, for instance implemented as data processing products, are described in greater detail hereafter.

Since the diagram is of the functional type, in a possible embodiment each block can be housed by different hardware or software modules, or—vice versa—multiple functional blocks can be enclosed in a single embodying module.

The reference 10 indicates in particular a teacher interface (typically housed on a personal computer) such as to allow the teacher to select which supports to the lessons to use (for instance, normal JPEG slides, or successive screens of a PowerPoint® presentation), controlling the quality data of the lesson (for instance by varying the video bit rate), starting, pausing the lesson, changing the layout of the presentation to the student (or the student's graphic interface) according to the importance of the different video contributions, etc.

From the functional viewpoint, the data set by the teacher on the interface 10 directly influence the module indicated as 12, serving as a streamer, and the timing of the elementary data, such as the shifting of the slides.

The reference 2 indicates, in the diagram of FIG. 2 as well, the sources already considered in the diagram of FIG. 1, whilst the modules 14 and 16 are modules respectively serving compressor/encoder and security safeguard functions. The multimedia stream generated by the streamer module 12 can be directly forwarded on a transmission channel 18 or transmitted towards a recorder 20 able to produce a recorded support 21 (Hard Disk, DVD-ROM, CD-ROM, coded for instance in MP4, file storage format of the MPEG4 standard).

In particular, the compressor/encoder module 14 is the one through which the elementary audio, video, slide, etc. are encoded to generate respective bit streams.

Said encoders operate according to formats that are compatible with provided transmission standards and—in a preferred manner—carry out parametric coding functions, for which it is therefore possible selectively to vary the coding parameters.

This allows, for example, selectively to switch from an audio signal with the typical bandwidth of a voice transmission to an audio signal with high fidelity characteristics, for instance to allow students to listen to a phonendoscope auscultation signal.

The inputs to the respective encoders therefore accept commands for configuring the teacher interface that are useful to adapt to different transmission bit rates (for instance modem, LAN or hard-disk) and/or to the type of source to be coded.

The module 12 comprises one or more modules that performing the function of sending the multimedia contents in the form of objects on various transmission supports such as LANs based on the IP protocol, satellite, etc. The output of the module 12 is therefore an interactive multimedia stream.

The recorder module 20 can be present on different stations or terminals, and even in co-presence with the streamer and in multiple instances. The module 20 has the purpose of acquiring the different elements that compose the lesson and storing the lesson in standard format so that it is viewable afterwards from a fixed supports, such as Hard Disk, CD-ROM, etc. or from the network through an appropriate server.

The reference 22 indicates a module with template function, which encloses in one or more text files the description of the student's graphic interface and its different capabilities of interacting with the system (for instance, enlarging and moving a video, navigating among the slides independently from the teacher, etc.). The module 22 contains, in a given language, a parameter set that allows to adapt to the teacher's choices and to the characteristics of the lesson (for example, the number of slides, order of presentation, etc.).

For instance, this language provides the capability to define the dimension and position occupied, in the student interface, by the image produced by the projector, or the capability, for the student, of navigating among the slides/transparencies transmitted by the teacher.

All this wholly independently from the dimensions and position originally attributed by the teacher to the aforesaid projector image, or, in regard to the slides and transparencies, independently from the cadence or from the order with which the teacher had presented/presents/will present said slides during his/her lesson.

This possibility exists specifically because the objects corresponding to the aforesaid projector image and/or to the aforesaid slides/transparencies are associated, in the multimedia stream transmitted towards the student, to the respective description and space-time characterisation. All this with the possibility, for the teacher, to modify the space-time position of the objects in question relative to the other information streams included in the multimedia stream.

The structure of the template module 22 allows to move the directing function from the teacher side to the student side, making it superfluous to resort to an outside entity.

The reference number 24 indicates a double functional block having the function of operating as a template processor (or instancer)/scene and object encoder (or descriptor).

The description in the form of a single function block takes into account the fact that the two parts comprising the block 24 are closely correlated to each other.

The processor part reads the template provided by the module 22 and receives the commands in real time from the interface 10. All this in order to generate the instantaneous updating of the student interface (for example, changing the foreground of a video, displaying a particular slide, etc.).

The part with scene encoder function receives the aforesaid instantaneous updates and encodes them in a compressed format, compatible with the reference standard.

The encoder associates to each object (which in this case is a single video, a slide, an audio, etc.) its description and space-time characterisation (object characterisation); this feature is directed to permit to interact on the characterised objects independently from the transmitter. The description of the objects is encoded according to the reference standard and constitutes an element of particular importance because through the related description it is possible to move the direction from the transmitter to the receiver.

The reference number 26, lastly, indicates an additional module which, in co-operation with the module 16, accomplishes the protection of the lesson, if provided (or even of just some of the objects that constitute the lesson) in order to allow to a protection management system (non shown, but known in itself) to control accesses and protect the information contents, for instance using cryptographic keys.

The computer or the computers 5 whereof the students D1, . . . , Dn are provided (FIG. 1) substantially correspond to the organisation represented in FIG. 3.

In this case, the reference number 30 indicates a network receiver constituted by one or more modules that perform the function of receiving the multimedia contents in the form of objects from various transmission supports 32 such as LANs based on the IP protocol, satellite, etc. The output of the receiver 30 is a series of interactive multimedia streams, structurally similar to those coming from a support reader 34.

The latter module 34 has the function of acquiring the different elements comprising the lesson from a physical support 36 support, providing the various mechanisms for any search requested by the student. In this case as well, the output of the module 34 is a series of interactive multimedia flows, similar to those of the network receiver, but coming from the physical or recorded support 36.

The reference numbers 38 and 40 indicate two modules that perform essentially complementary functions with respect to those of the modules 16 and 26 of FIG. 2, i.e. any decryption of the lesson (or even of just some of the objects comprising it) in order to allow (here, too, with an access control system not illustrated but known) to control accesses and protect the contents.

The reference 42 indicates a set of decompressor/decoder modules through which the elementary streams of audio, video, slides, etc. are decoded in real time starting from the form prescribed by the standard towards a format immediately usable for displaying the student interface, indicated as 44.

As was the case for the compressor/encoder of the block 14 described above, the decompressor/decoder 42 can also be advantageously configured in such a way as to operate in parametric fashion (usually according to a corresponding variation in the coding parameters on the transmitter/student side), thereby allowing, for example the decoding of a certain segment of audio signal with high fidelity characteristics within an audio signal that normally has the characteristics of a voice audio signal.

Between the set of modules 42 and the student interface 44 is inserted a double functional block 46 with interpreter/composer functions. The block 46 is destined to perform a function that is substantially homologous or complementary to the function performed by the block 24 under the control of the template 22. Hence, also the block 46 is a double functional block shown as a single element since the two parts comprising it are closely correlated to each other.

The interpreter part receives, decompresses and interprets the instantaneous updating of the student interface 44 (for instance, changing the foreground of a video, displaying a particular slide, etc.). It also interprets, for each object (and in this context, an object is a single video, a slide, an audio, etc.), description and space-time characterisation, so that the receiver can interact on the objects independently from the transmitter. The description of the objects is coded according to the reference standard and constitutes an important part of the invention since only by means of this description is it possible to move the direction from the transmitter to the receiver.

The composer part receives both the description of the objects and the updates of the interface 44 and the interactions by the student. Based on the combination thereof, it decides how many and which decoded elementary objects it is to display, as well as how to do so, passing them to the student interface 44.

Through the interface 44, each student D1, . . . , Dn—wholly independently from the others—can select (naturally, within the limits set by the teacher) which lesson supports to display. In particular, each student D1, . . . , Dn can—once again, it is stressed: wholly independently from the others —select which slides to display among all those transmitted, recall previously viewed slides, preview any slides not yet shown by the teacher, pause the lesson (which leads to a loss of part of the less if the lesson is online, unless it is temporarily stored), end the display, change the layout of the visuals—all within the limits allowed by the teacher's module 22—according to the importance of the different video aids.

Essentially, the solution according to the invention provides students with a triple fruition capability.

In a first mode (live streaming), the student can view the lesson in real time, i.e. as it is given with the interactions allowed by the template. From the teacher side, the stream is created directly by the streamer 12 by reading the flows coming in real time from the modules 16, 26 and 10. From the student side, the module 34 obviously remains inactive while the module 30 is active.

A second mode (delayed streaming) allows the student to review the lesson after a delay, requesting it from an appropriate server that previously stored it. It is not necessary to wait for the lesson to be downloaded entirely, but rather it is possible immediately to start viewing it. From the teacher side, the stream is created by the streamer 12 by reading one or more MP4 files coming from a mass support 12a, previously recorded by means of the module 20. On the student side, in these conditions the module 34 remains inactive while the module 30 is active.

A third mode (download) allows the student to view the lesson after a delay, requesting it from an appropriate server that previously stored it. In this case it is necessary to wait for the lesson to be downloaded completely and then it is possible to view it several times without having to reconnect to the server.

From the teacher side, the stream is created by the streamer 12 by reading one or more MP4 files coming from the mass support 12a, previously recorded by means of the module 20. From the student side, the support reader module 34 is activated, while the network receiver module 30 remains inactive.

In actual cases of employment of the system according to the invention, the envisioned use of machines typically involves four computer profile, independently of the function diagram.

A first computer is constituted by the personal computer of the teacher T. Through it, the teacher can use the slides and give the lesson through the teacher interface 10.

A second computer, for instance a content creation personal computer, is the machine whereon the sources, constituted by the television cameras, by the microphone, and the other modules provided in FIG. 3, are connected; Such a second computer, for instance, further comprises the template module 22.

It is also possible for the functions of the teacher's computer to be performed by the content creation personal computer.

A third machine is constituted by a server, for instance of the HTTP/MP4 type, whereon are present the recorded lessons and usually the recording module 20. For reasons of efficiency, it is better to keep this computer separate from the content creation computer.

As a fourth machine profile, there are the receiving computers 5, present in a number equal to the number of the students. Each of these computers houses the functionalities shown in FIG. 3.

In regard to streamer types, use of a multicast streamer allows to multicast the audio and video contents and the other information produced. This type of streamer simultaneously transmits the same information to all receivers that request it.

If instead a unicast type of streamer is used, it is possible to unicast the audio and video contents and other information produced. In particular this type of streamer transmits the information only to the receiver who makes the request.

In case of new requests for the same multimedia contents (same lesson), the server activates a new session for each request, allowing different students to view the same lesson at different times. In particular, this enables each student to follow the lesson starting from the beginning, handling the viewing of the lesson independently from the other students' viewing modes.

A third type of streamer is represented by the FTP/HTTP server: thence the students can start to search ongoing or recorded lessons and having the reference (for instance the URL) to:
a multicast streamer as described above,
a unicast streamer as described above,
an MP4 file viewable immediately from the FTP/HTTP server as a progressive HTTP or viewable, at the end of the download process, in FTP download or HTTP download mode.

Typical procedures for using the system according to the invention provide for the teacher T to prepare the lesson for instance with PowerPoint® or JPEG slides, and any other support materials to be presented during the lesson (on paper, videocassette, personal computer, etc.). The teacher T can use his/her own portable Personal Computer to be connected to the coding station or use a support such as a diskette to transfer the slides thereto. The teacher T is provided with a specific interface for the remote or local control of the coding station (preview, fast forwarding, times, etc.). The coding station also provides for sending and recording the acquired items in real time.

The student is able to connect to the system 1 through a mid-range multimedia personal computer, configured (for instance by means of a plug-in module) in such a way as to perform the functions corresponding to the diagram of FIG. 3. Through Ethernet, modem or satellite interface (or any other means) the student connects to the machine where the pre-recorded or ongoing lessons are available, logs in, selects the lesson that (s)he is interested in and can immediately start viewing (streaming) or downloading.

For the security and content protection function, any decision about how many and which streams are to be encrypted is referred to the protection management system: the system described herein provides for applying the algorithm in real time and to pass the data to the streamer or recorder.

The streamer receives the data from encoder and sends them, for instance on RTP protocol, according to globally known mechanisms. The recorder 20 produces all streams in a single multimedia file in standardised MP4 format.

In summary, the system according to the invention allows to achieve the transmission (for the meaning to be attributed to the term “transmission”, reference is once again made to the definition thereof provided at the outset of the present description) of a multimedia stream between a transmitter 3 and at least a receiver 5. The multimedia stream comprises at least an audio/video stream whereto is associated at least an auxiliary information stream, such as a video stream corresponding to the signal generated by a projector, a stream corresponding to slides or transparencies, etc. To at least some of the objects included in the aforesaid multimedia stream is associated a respective description and space-time characterisation. The receiver 5, or each receiver 5, is therefore able to interact with said objects, changing their space-time position relative to the other streams, independently from said transmitter 3.

Naturally, without changing the principle of the invention, its constructive details and embodiment can vary widely with respect to what has been described and illustrated herein, without thereby departing from the scope of the invention, as defined in the accompanying claim.

1. System (1) for transmitting a multimedia stream between at least one transmitter (3) and at least one receiver (5), characterised in that said multimedia stream comprise at least an audio/video stream with at least an auxiliary information stream associated thereto, said audio/video and auxiliary streams comprising respective objects, and in that, in said multimedia stream, to at least some of said objects is associated a respective description and space-time characterisation, so that said at least one receiver (5) is able to interact with said objects, modifying their space-time position in said multimedia stream, independently from said at least one transmitter (3).

2. System as claimed in claim 1, characterised in that said multimedia stream comprises at least a continuous audio/video stream and a second video stream such as a video stream generated by a projector.

3. System as claimed in claim 1, characterised in that said auxiliary information stream comprises at least a synchronisation component of said auxiliary information stream relative to said audio/video stream, so that said at least one receiver (5) is able selectively to change the synchronisation of said auxiliary information stream relative to said audio/video stream.

4. System as claimed in claim 1, characterised in that said at least an audio/video stream is subjected to MPEG-4 encoding.

5. System as claimed in claim 1, characterised in that said auxiliary information stream conveys information corresponding to slides or transparencies.
transparencies.

6. System as claimed in claim 5, characterised in that said auxiliary information stream is encoded according to a format selected in the group constituted by the JPEG format and by the PowerPoint format.

7. System as claimed in claim 3, characterised in that said at least one receiver (5) is configured for a function of navigating through the slides or transparencies of said auxiliary information stream.

8. System as claimed in claim 1, characterised in that it comprises, on the side of said at least one transmitter (3), an interface (10) usable to select at least a parameter chosen in the group constituted by
supports to use,
transmission quality,
start, pause, and end of a transmission, and
change of presentation layout of said multimedia stream.

9. System as claim in claim 1, characterised in that it comprises, on the side of said at least one transmitter (3), a module with template function (22) containing at least a text file with the description of the graphic interface at the level of said at least one receiver (5).

10. System as claimed in claim 9, characterised in that said template module (22) allows selectively to modify the associate criteria of said at least an auxiliary information stream relative to said at least an audio/video stream.

11. System as claimed in claim 1 characterised in that it comprises, on the side of said at least one transmitter (3), a scene encoder module (24) able to associate said description and characterisation to each of said objects, said description being encoded according to a reference standard.

12. System as claimed in claim 1, characterised in that it comprises, on the side of said at least one transmitter (3), at least a module (16, 26) able to render selectively conditioned the access to at least part of said multimedia stream by said at least a receiver.

13. System as claimed in claim 1, characterised in that it comprises, on the side of said at least a transmitter (3), a streamer module (12) able to generate said multimedia stream in the form of interactive multimedia stream viewable in real time.

14. System as claimed in claim 1, characterised in that it comprises, on the side of said at least one transmitter (3), a recorder module (20) to record said multimedia stream on a recording support in view of allowing its delayed viewing.

15. System as claimed in claim 1, characterised in that it comprises, on the side of said at least one receiver (5), an interpreter/composer module (46) able to detect said description and characterisation of said objects in said multimedia stream, allowing said at least one receiver (5) to interact on said objects independently from said at least a transmitter (3).

16. System as claimed in claim 15, characterised in that said interpreter/composer module is configured to receive both the description of said objects and any updates of an interface/interactions on the side of said at least one transmitter (3).

17. System as claimed in claim 1, characterised in that it comprises, on the side of said at least one receiver (5), a receiver interface module {44) able to allow the selective identification, for purposes of the presentation of said multimedia stream, of at least a parameter selected in the group constituted by:
selectively displaying the objects of said auxiliary information stream,
placing the transmission on pause,
interrupting the transmission,
changing the visual contents of the transmission.

18. System as claimed in claim 1 characterised in that it comprises, on the side of said at least one, receiver (5), at least a protection module (38, 40) able to affect the viewing of at least part of said multimedia stream at the level of said at least one receiver (5) upon the insertion of a decryption key in said at least a receiver (5).

19. System as claimed in claim 1, characterised in that it comprises, on the side of said at least one receiver (5), a network receiver module (30) for receiving said multimedia stream in real time.

20. System as claimed in claim 1, characterised in that it comprises, on the side of said at least one receiver (5), a module support reader module (30) for reading said multimedia stream from a respective recording support (12a).

21. Method for transmitting a multimedia stream between at least one transmitter (3) and at least one receiver (5) comprising the steps of
collecting multimedia streams having a plurality of objects,
selectively associating to said objects of said multimedia streams respective characterising information for describing and characterising said objects as characterised objects,
transmitting said characterised objects so that said at least one receiver (5) is able to interact with said characterised objects independently from said at least one transmitter (3).

22. Method according to claim 21 characterised in that said step of selectively associating comprises the steps of
associating to said objects a description and/or a space/time characterisation as a directing function associated to said at least one transmitter (3).

23. Method according to claim 22, characterised by the further steps of
interpreting said characterised objects; and
selectively move said directing function from said at least one transmitter (3) to said at least one receiver (5).

24. Data processing product, directly loadable into the internal memory of a digital processor and including parts of software code to perform the method according to claim 21, when the product is run on a digital processor.
